(19) United States
(12) Patent Application Publication
(10) Pub. No.: US 2026/0348216 A1
(43) Pub. Date: Nov. 5, 2026

(54) CONFIGURABLE HINGE DEVICE

(71) Applicant: C.M.I. CERNIERE MECCANICHE INDUSTRIALI S.R.L., VALSAMOGGIA (BO) (IT)

(72) Inventor: Emanuele Terenzi, Sala Bolognese (IT)

(21) Appl. No.: 19/124,575

(22) PCT Filed: Oct. 31, 2023
(86) PCT No.: PCT/EP2023/080422

§ 371 Date: Apr. 25, 2025

(30) Foreign Application Priority Data
Nov. 3, 2022 (IT) 102022000022569

(51) Int. Cl. E05F 1/12; E05F 3/16; E05F 3/20

(52) U.S. Cl. CPC E05F 1/1261; E05F 3/16; E05F 3/20; E05Y 2201/21; E05Y 2201/224; E05Y 2201/26; E05Y 2201/264; E05Y 2201/626; E05Y 2900/20; E05Y 2900/30

(57) ABSTRACT

One of a first (3) or a second (5) member of a configurable hinge device includes an elastic element (8) acting on a first end of a lever element (11) pivoted, by means of a fulcrum pin (12) to the first (3) or second (5) member carrying the elastic element (8) where the action portion (10) of such lever element (11), opposite to the first end, acts on the other second (5) or first (3) member transmitting it the elastic closing force generated by the elastic element (8).

### TECHNICAL FIELD

The present invention relates to the technical field concerning hinges for household appliances and furniture and refers to a configurable hinge device, that is predisposed to perform certain functions or performances by means of the possible application of parts and accessories of the device itself.

In particular, the device can be configured as a normal hinge or for balancing heavy front panels or for lifting the front panels during opening to avoid interference of the lower edge of the panels with bases or other lower elements of the appliance or the environment where it is installed.

### PRIOR ART

There are known hinges, for example for dishwashers or ovens, suitable for normal use or for balancing particularly heavy decorative panels or for translating the panel away from the hinge during opening.

A disadvantage of these known hinges consists in that they are designed and manufactured specifically for the functions for which they are assigned and therefore require the production sites to be provided with stocks of all three types.

Furthermore, there are known hinges which can be set up during production or adjusted during assembly to the household appliance to balance panels of different weights, but these arrangements or adjustments generally require tools and/or operations which the installer is not allowed or able to perform onto the household appliance, apparatus or furniture in place.

Another disadvantage of these known hinges consists in the fact that they are difficult to install in household appliances or furniture due to the fact that they must be fixed to the body and door of the appliance or furniture.

Prior art documents US2010/148646A1, US2007/193572A1 and U.S. Pat. No. 10,070,4311B1 disclose a device according to the preamble of claim 1 of the present document.

### DISCLOSURE OF THE INVENTION

An object of the present invention is to propose a hinge device that can be configured in a simple and economical way, by means of simple optional elements to move a decorative panel connected to the door of the appliance provided with this device.

A different object of the present invention is to propose a hinge device that can be configured in a simple and economical way, by means of simple optional elements to modify the elastic closing force to compensate different weights of the door and possibly of the respective panel, of the device provided with this device.

Another object is to propose a hinge device capable of modifying the closing force according to the opening angle, guaranteeing stable closure and compression of any door seals.

A further object is to propose a hinge device capable of braking the rotation of the door constantly and/or depending on the opening angle.

Another object is to propose a hinge device that can be configured without the need for specific tools, even by the installer of the household appliance or furniture.

Another object is to propose a hinge with the two members, fixed and rotatable respectively, separated and connectable, even during the assembly phase of the appliance or furniture, by means of a pin after their fixing.

A further object is to propose a reliable, relatively economical and silent hinge.

### BRIEF DESCRIPTION OF THE DRAWINGS

The characteristics of the invention are highlighted below with particular reference to the attached drawings in which:

FIGS. 1-4 illustrate respectively front, one side, rear and opposite side views of the configurable hinge device object of the present invention in a closed condition;

FIGS. 5 and 6 illustrate axonometric views of the device of the previous figures in which, in FIG. 6 alone, some parts have been removed to better highlight others;

FIG. 7 illustrates an axonometric and partial view of the device of the previous figures in an open condition;

FIG. 8 illustrates the device of the previous figures in a closed condition and in which some parts have been removed to better highlight others;

FIGS. 9 and 10 illustrate partial views of an elongated detail of FIG. 8 sectioned by respective mutually orthogonal planes passing through the longitudinal axis of such detail;

FIG. 11 illustrates the device of the previous figures in a partially open condition and in which some parts have been removed to better highlight others;

FIGS. 12 and 13 illustrate partial views of an elongated detail of FIG. 11 sectioned by respective mutually orthogonal planes passing through the longitudinal axis of such detail;

FIG. 14 illustrates the device of the previous figures in open condition and in which some parts have been removed to better highlight others;

FIGS. 15 and 16 illustrate partial views of an elongated detail of FIG. 14 sectioned by respective mutually orthogonal planes passing through the longitudinal axis of such detail;

FIG. 17 illustrates an exploded axonometric view of the device of the previous figures;

FIGS. 18-21 illustrate respectively front, one side, rear and opposite side views of a variant of the configurable hinge device of FIG. 1;

FIG. 22 illustrates an axonometric and partially exploded view of the device of FIGS. 18-21.

### BEST MODE TO CARRY OUT THE INVENTION

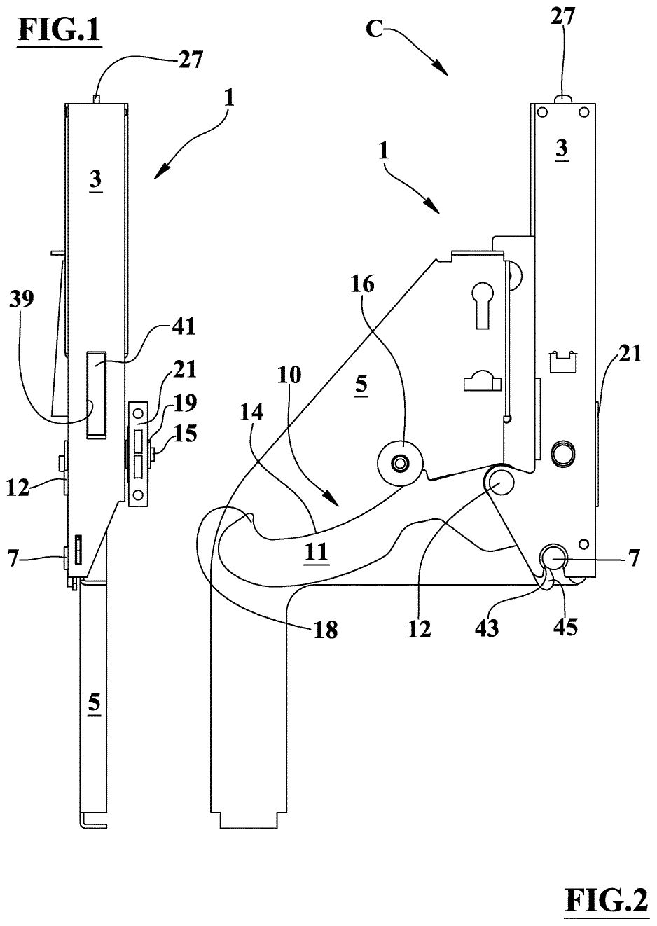

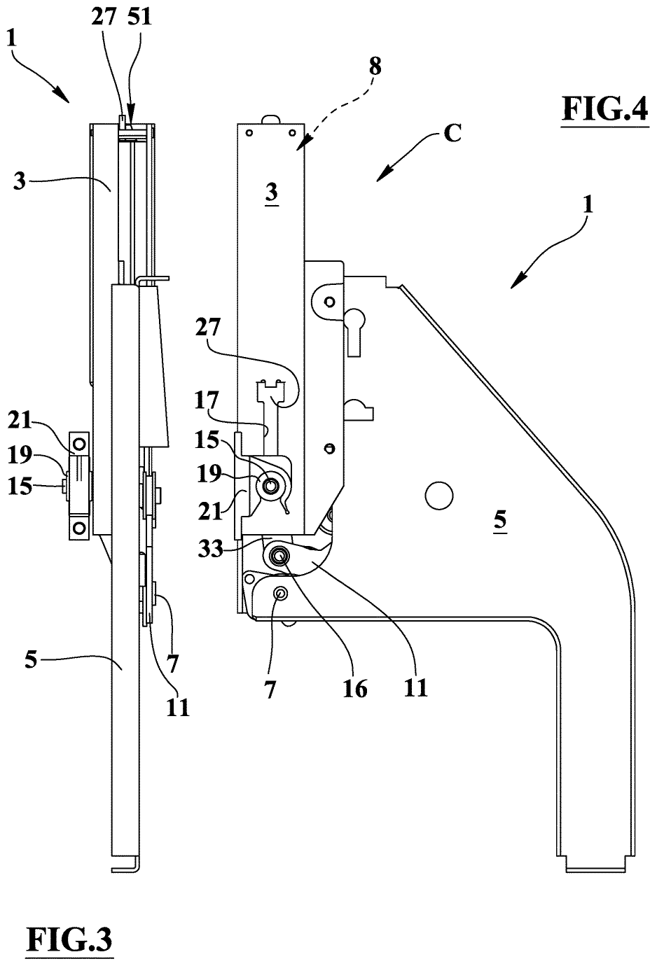

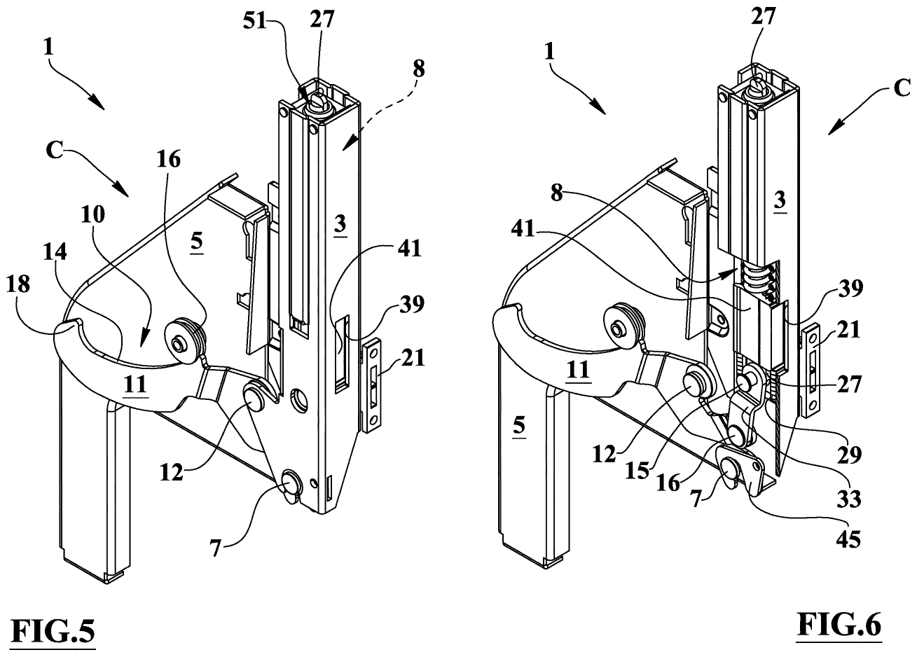

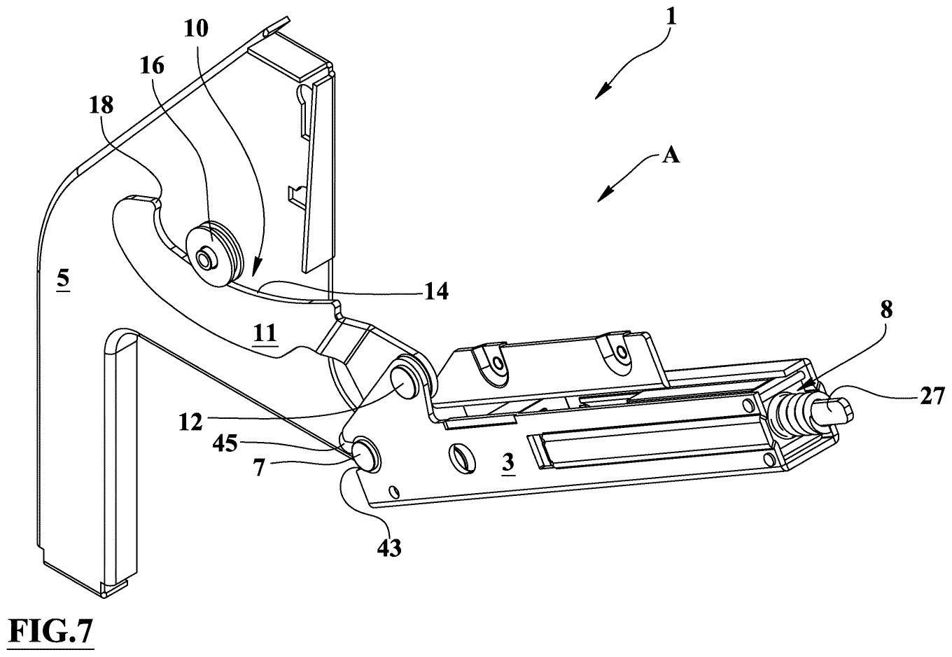

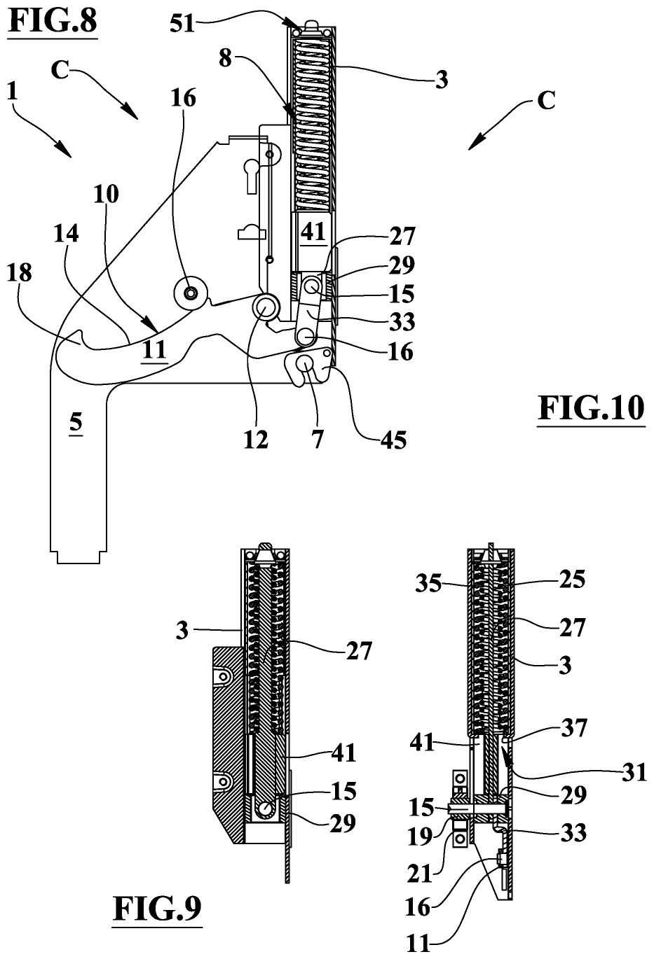

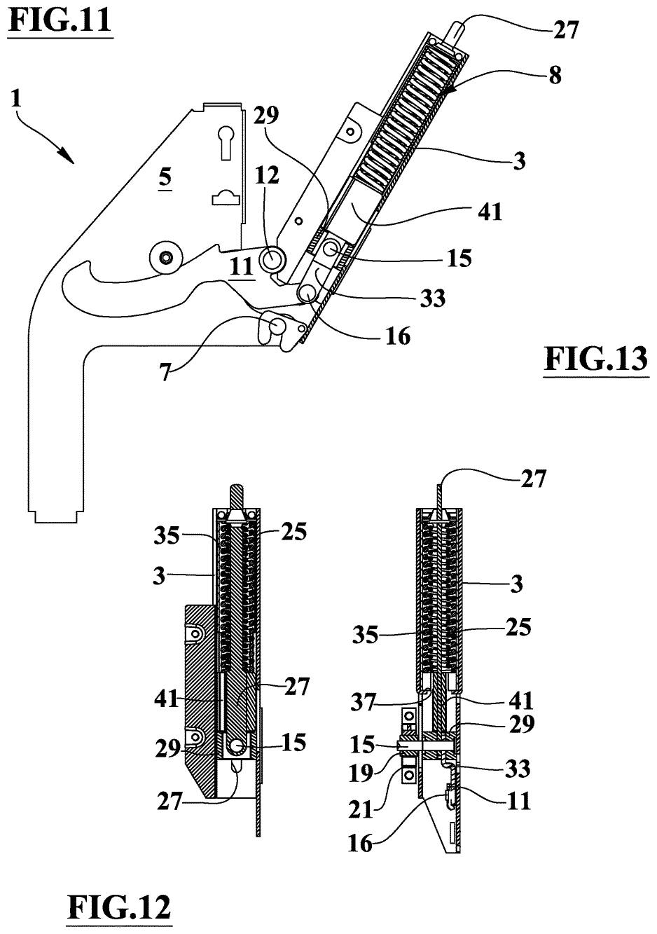

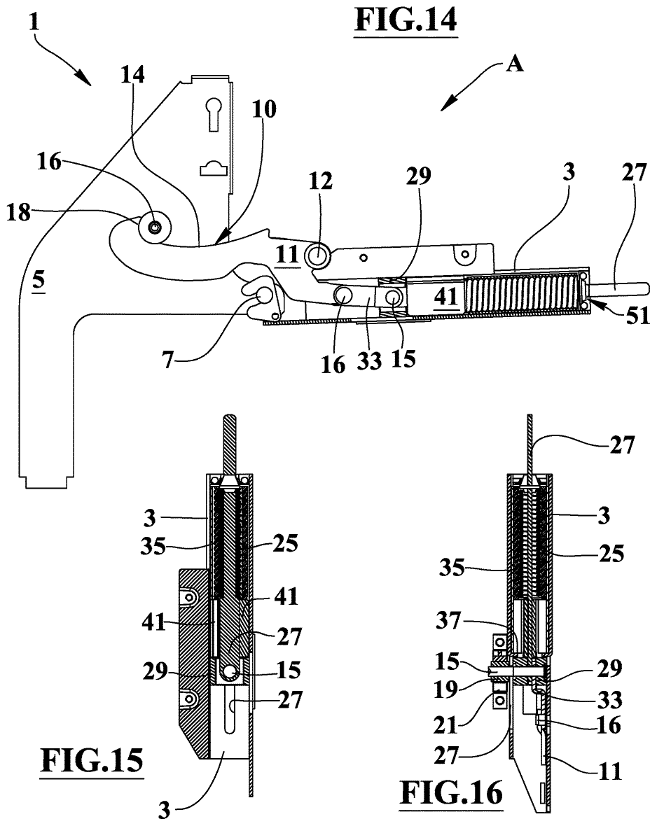

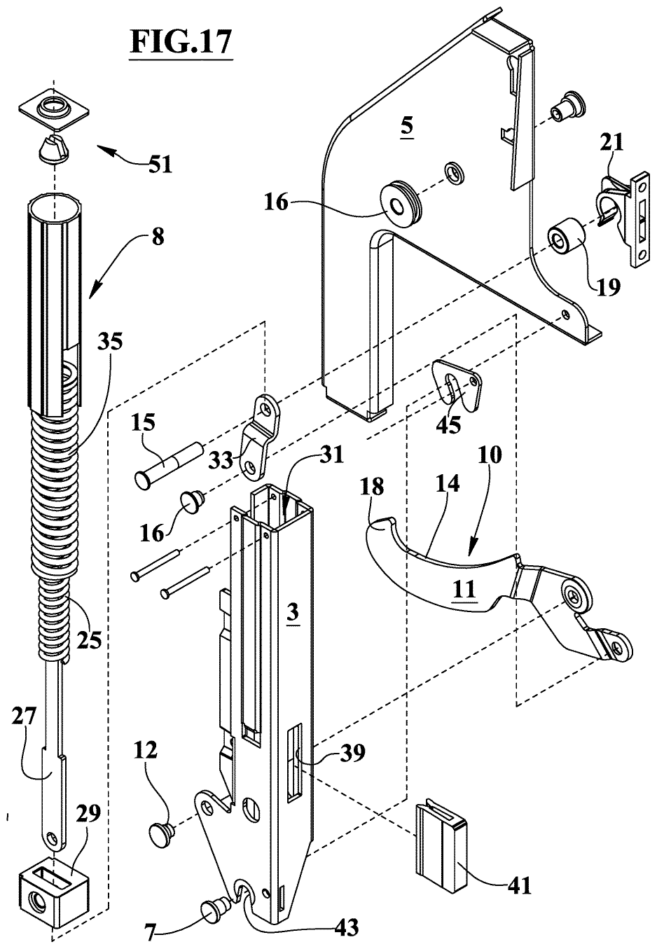

With reference to FIGS. 1-17, numeral 1 indicates the configurable hinge device object of the present invention. Such device, in its minimal configuration, can comprise a first member 3 assigned to be fixed to a door of a household appliance, apparatus or furniture and a second member 5 assigned to be fixed to a body or frame of the household appliance, apparatus or furniture, or vice versa.

These first 3 and second 5 members are mutually connected or connectable by means of a hinge pivot pin 7 and rotatable with respect to each other around the axis of such hinge pin between a closed condition C of the hinge 1, in which the door occludes an opening of the body of the household appliance, and a maximum opening condition A of the hinge 1, in which the door forms a maximum opening angle with the plane defined by the edge of the opening.

The first member 3 comprises an elongated and hollow portion, for example made by bending a sheet metal plate of which this member is made, to obtain a sort of box that defines a cavity 31 which at least partially houses an elastic element 8 acting on a first end of a lever element 11 pivoted, by means of a fulcrum pin 12 to the first member 3 which, as seen, carries the elastic element 8. Such lever element 11 comprises an action portion 10 which, with respect to the fulcrum pin 12, is opposite to the first end of this lever element.

Said action portion 10 acts on the second member 5, transmitting to it the elastic closing force generated by the elastic element 8.

The end of the elastic element 8 closest to the hinge pivot pin 7 carries a first connection pin 15 preferably protruding from the first member 3 through a respective optional first slot 17 oriented radially with respect to the hinge pivot pin 7.

The portion of the first connection pin 15 protruding from the respective member 3 is assigned to carry an optional connection bushing 19 of the device 1 assigned to connect to an attachment 21, also optional, of the device 1.

Such first group of optional elements: protrusion of the first connection pin 15, first slot 17, connection bushing 19 and attachment 21, allow to move a covering panel of the appliance door towards and away from the hinge pin during the closing and opening rotations of the door. To obtain such configuration it is sufficient to fix the attachment 21 to a front panel and fit a specific cavity of such attachment to the connection bushing 19 engaged with the connection pin 15 protruding from the respective member 3 through its first slot 17. The elongation and shortening of the elastic element 8 during the opening and closing rotations causes the translation of the protruding connection pin 15 and therefore of the connection bushing 19, of the attachment 21 and of the panel fixed to it. Naturally, both the left and right specular hinges of the appliance collaborate in moving the panel.

The elastic element 8 of the device 1 comprises at least a compressed first spring 25, having one end locked at a distal end, that is opposite to the hinge pivot pin 7, of the respective member 3. The opposite, that is proximal, end of the at least one first spring 25 acts on its spring guide 27, for example in the shape of an elongated flat rod, of the elastic element 8, pressing it elastically towards the hinge pin.

The proximal end, that is turned towards the hinge pivot pin 7, of the spring guide 27 has a seat for the first connection pin 15 which connects the spring guide 27 itself to a sliding element 29 which translates within the cavity 31, or along a guide of the first member 3 carrying the elastic element 8. The cavity 31, or the guide, are arranged radially or according to a geometric straight-line incident with and perpendicular to the axis of rotation of the hinge pin.

The first connection pin 15 also connects the spring guide 27 to one end of a connecting rod member 33 whose opposite end is pivoted to the first end of the lever element 11 by means of a second pin 16.

The elastic element 8 of the device 1 can comprise an optional second spring 35 coaxial and external to the first spring 25 and having a distal end locked to the end of the respective first member 3 and the opposite proximal and mobile end abutting with an optional shoulder 37 of the first member 3 which prevents its further extension towards the hinge pin by keeping the second spring 35 separated from the sliding element 29 by a distance which is maximum when the device 1 is closed.

The first member 3, carrying the elastic element 8, has an optional opening 39 for access to the cavity 31, or to the guide, for the introduction and positioning of an optional transmission element 41 between the mobile end of the second spring 35 and the sliding element 29 and movable in the cavity 31.

The transmission element 41 has a longitudinal development equal to or slightly less than or slightly greater than said maximum distance and has a longitudinal seat assigned to house a portion of the spring guide 27 for fixing the transmission element 41 itself to said spring guide 27.

This second group of optional elements: second spring 35, shoulder 37, opening 39 and transmission element 41, possibly present in device 1 with or without the optional elements of the first group, allows the elastic closing force of the hinge to be modified, for example to balance the weight of a heavy door or any panel, by simply inserting through the opening 39 the transmission element 41 into the device 1 in a closed condition.

It should be noted that the basic architecture of the device allows it to be set up for basic operation or for one or both of the functions permitted by one or both groups of optional elements.

The first arm of the lever element 11, comprised between its first end—on which the elastic element 8 acts—and the fulcrum pin 12, is shorter in length than the other and second arm comprised between said fulcrum pin 12 and the point of the action portion 10 of this lever element 11 which acts on the second member 5 opposite to the one carrying the elastic element 8 and to which it transmits the elastic closing force generated by the elastic element 8 itself.

The action portion 10 of the lever element 11 comprises an edge of such element or a track or rail 14 for sliding or rolling matching with a pin or preferably with a rotating wheel 16 axially fixed to the second member 5 to transmit the elastic closing force to it.

The track or rail 14 is straight or preferably curved and the respective end opposite to the hinge pivot pin 7 carries an abutment 18 to abut and stop the pin or rotating wheel 16 in the open condition A.

The hinge pivot pin 7 can be rotatably engaged in respective circular seats obtained in the first and second members or has one end fixed to the second member 5 and is engaged in an open seat or slot 43 obtained in the other and first member 3. The first member, near the open slot 43, has a revolving U-shaped element 45 pivoted to it and assigned to reversibly lock the hinge pivot pin 7 into the seat or open slot 43. Such connection of the hinge pin allows the first and second members to be kept separate, facilitating their fixing respectively to the door and to the body of the appliance and to fasten them to each other by means of the hinge pin only later; furthermore, such connection allows the door to be separated and reunited with the appliance, for example for cleaning or maintenance.

The elastic element 8 comprises a friction means 51 provided with a conical seat, for example made of cut and pressed-formed metal sheet, fixed to the end of the respective member 3, 5 which blocks the first spring 25 and the second spring 35. The vertex geometric shape of the conical seat faces in the opposite direction to the hinge pivot pin 7. Such concave seat of the friction means 51 houses two wedge-shaped elements, for example made of plastic material, with an overall shape approximately complementary to the conical seat. The spring guide 27 slides between the two wedge-shaped elements and at least one of the two first spring 25 and second spring 35 acts on them, tightening them against the spring guide, especially when the device is open, braking its rotation, particularly in the final opening phase.

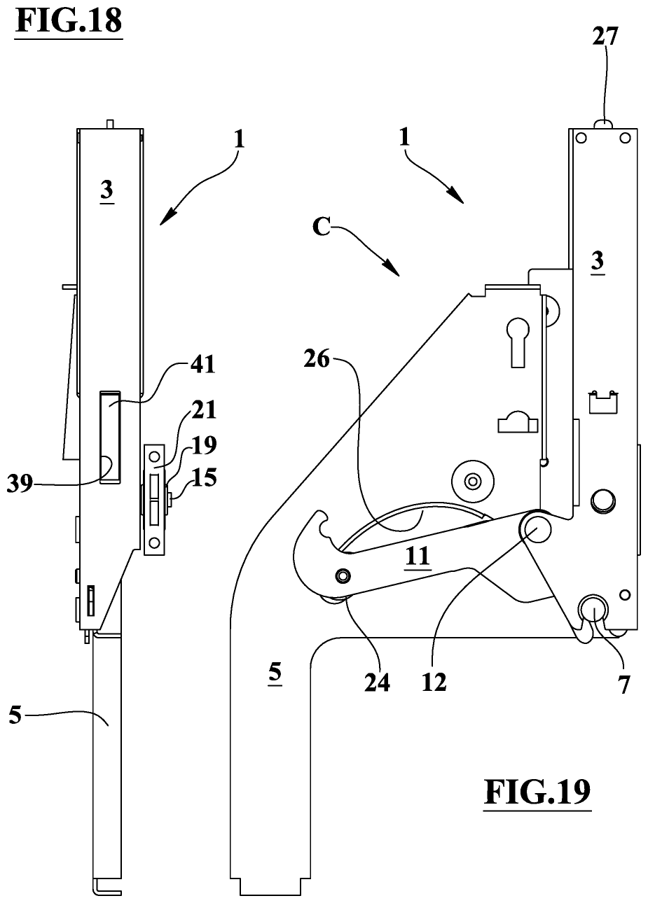

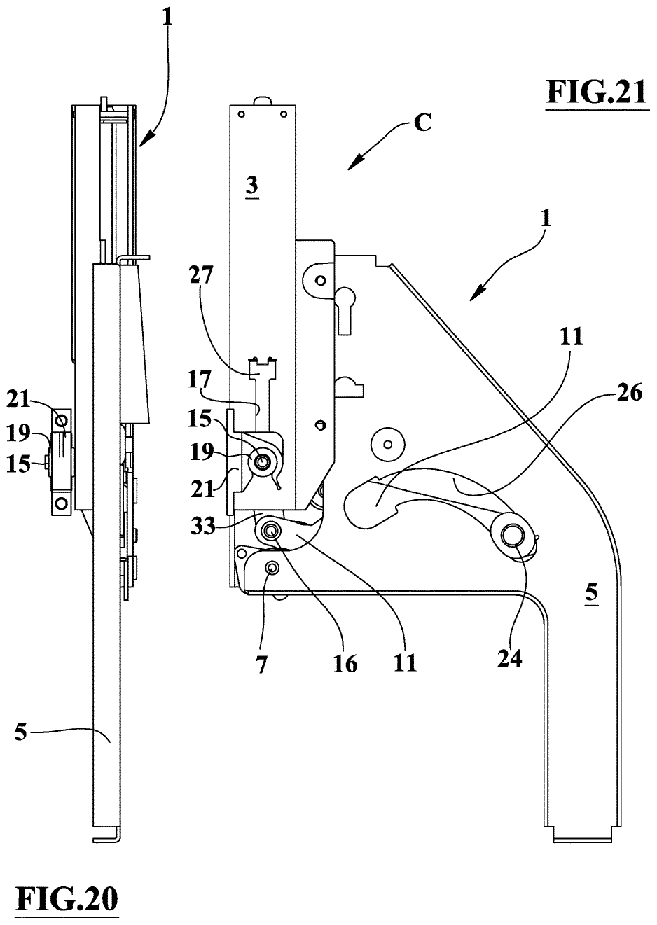

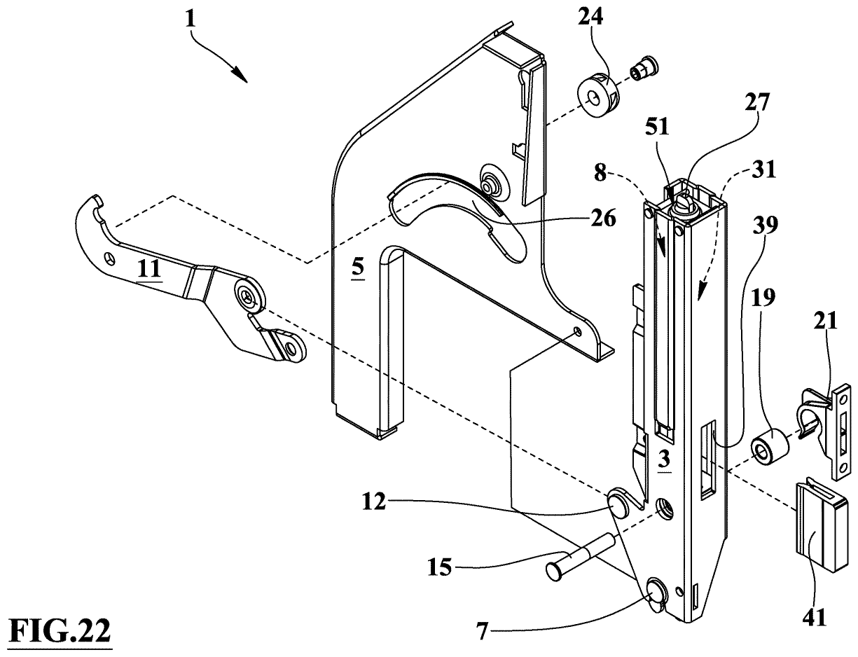

The variant of FIGS. 18-22 differs from the previous embodiments in that the action portion 10 of the lever element 11 comprises a sliding or rolling element 24 axially fixed to the end portion of the lever element 11 opposite the hinge pivot pin 7. Such sliding or rolling element 24 is movable along a guide or an edge of a second slot 26 of the second member 5 to transmit the elastic closing force to such member.

The guide or edge of the second slot 26 is straight or and preferably curved and its end close to the hinge pivot pin 7 is shaped to match the sliding or rolling element 24 in the maximum opening condition A. Optionally the second slot 26 can be shaped to match the sliding or rolling element 24 with constant or variable friction, for example by regulating the width of the second slot 26 so that it tightens the sliding or rolling element 24 in a constant or variable way.

The invention provides that the positions of the various elements on one or the other of the two first or second members can be reversed while maintaining the peculiarities and functionality of the device 1.

1) Configurable hinge device comprising a first member (3) and a second member (5), mutually connectable by means of a hinge pivot pin (7), assigned to be fixed respectively to a door or to a body of an appliance or vice versa, and rotatable with respect to each other between a closed condition (C) of the hinge device (1), in which the door closes an opening in the appliance body, and a condition of maximum opening (A) of the hinge device (1), in which the door forms an angle of maximum opening with the plane defined by the edge of the opening; one of the first (3) or second (5) members comprises an elastic element (8) acting on a first end of a lever element (11) pivoted, by means of a fulcrum pin (12) to the first (3) or second (5) member carrying the elastic element (8) where the action portion (10) of such lever element (11), opposite to the first end, acts on the other second (5) or first (3) member transmitting it the elastic closing force generated by the elastic element (8); the hinge device (1) being characterized in that the end of the elastic element (8) closest to the hinge pivot pin (7) carries a first connection pin (15) protruding from the first (3) or second (5) member carrying the elastic element (8) through a respective first slot (17) oriented radially with respect to the hinge pivot pin (7); the portion of the first connection pin (15) protruding from the respective member (3, 5) is configured to carry a connection bushing (19) of the device (1) assigned to couple a mechanical coupling (21) of the device (1) and the mechanical coupling (21) can be fixed to a front panel for moving thereof when opening and closing the device (1).

2) Device according to claim 1, characterized in that the elastic element (8) comprises at least one first compressed spring (25) having one end blocked at one end of the respective member (3, 5) opposite the hinge pivot pin (7) and the opposite end acting on its spring guide (27) of the elastic element (8) whose end facing the hinge pivot pin (7) carries the first connection pin (15) which connects the spring guide (27) to a sliding element (29) translating within a cavity (31) or along a guide of the first (3) or second (5) member carrying the elastic element (8) and such first connection pin (15) also connects the spring guide (27) to one end of a connecting rod member (33) whose opposite end is pivoted to the first end of the lever element (11) by means of a second pin (16).

3) Device according to claim 2 characterized in that the elastic element (8) comprises a second spring (35) coaxial and external to the first spring (25) and having an end blocked at the end of the respective member (3, 5) opposite the hinge pivot pin (7), where the opposite and movable end of the second spring (35), matches a shoulder (37) of the first (3) or second (5) member carrying the elastic element (8), said shoulder being assigned to maintain the second spring (35) spaced from the sliding element (29) of a distance which is maximum when the device (1) is closed, the first (3) or second (5) member carrying the elastic element (8) has an opening (39) to access the cavity (31) or guide for the introduction and positioning of a transmission element (41) between the mobile end of the second spring (35) and the sliding element (29), where the transmission element (41) has a longitudinal development equal to or slightly less or more than said maximum distance and has a longitudinal seat assigned to accommodate a portion of the spring guide (27) for fixing the transmission element (41) to the latter.

4) Device according claim 1, characterized in that the first arm of the lever element (11) comprised between its first end, on which the elastic element (8) acts, and the fulcrum pin (12) is shorter in length than the other and second arm comprised between said fulcrum pin (12) and the point of the action portion (10) of this lever element (11) which acts on the second (5) or first (3) member opposite to that carrying the elastic element (8) and to which it transmits the elastic closing force generated by the elastic element (8) itself.

5) Device according to claim 4 characterized in that the action portion (10) of the lever element (11) comprises an edge of such element or a track or rail (14) for sliding or rolling abutment with a pin or rotating wheel (16) axially fixed to the second (5) or first (3) member opposite to that carrying the elastic element (8) to transmit the elastic closing force to such member.

6) Device according to claim 4 characterized in that the action portion (10) of the lever element (11) comprises a sliding or rolling element (24) axially fixed to the end of the lever element (11) opposite the hinge pivot pin (7) and movable along a guide or edge of a second slot (26) of the second (5) or first (3) member opposite to that carrying the elastic element (8) to transmit the elastic closing force to such member.

7) Device according to claim 1, characterized in that the track or rail (14) is straight or curved and its end opposite to the hinge pivot pin (7) has a relief or abutment (18) for checking and stopping the pin or rotating wheel (16) or the guide or edge of the second slot (26) is straight or curved and its end close to the hinge pivot pin (7) is shaped to meet the sliding or rolling element (24) in the condition of maximum opening (A).

8) Device according to claim 1, characterized in that the second slot (26) is shaped to meet the sliding or rolling element (24) with constant or variable friction.

9) Device according to claim 1, characterized in that the hinge pivot pin (7) has one end fixed to the second (5) or first (3) member and it (7) is engaged in an open seat or slot (43) obtained in the other second (5) or first (3) member carrying a revolving U-shaped element (45) assigned to reversibly lock the hinge pivot pin (7) in the open seat or slot (43).

10) Device according to claim 3, characterized in that the elastic element (8) comprises a friction means (51) provided with a conical seat fixed to the end of the respective member (3, 5) which blocks the first (25) and second (35) springs and with geometric vertex facing in the direction opposite to the hinge pivot pin (7) where this concave seat of the friction means (51) houses two wedge-shaped elements complementary to it and between which the spring guide (27) slides where at least one of the two first (25) and second (35) springs acts on these wedge-shaped elements.
